(19) United States
(12) Patent Application Publication
(10) Pub. No.: US 2012/0175564 A1
(43) Pub. Date: Jul. 12, 2012

(54) CONDUCTIVE POLYMER COMPOSITION AND CONDUCTIVE FILM PREPARED FROM THE COMPOSITION

(75) Inventors: Yong Hyun JIN, Seoul (KR); Youn Soo KIM, Seoul (KR); Sang Hwa KIM, Gyunggi-do (KR); Ji Soo LEE, Gyunggi-do (KR); Jong Young LEE, Gyunggi-do (KR)

(73) Assignee: SAMSUNG ELECTRO-MECHANICS CO., LTD., Gyunggi-do (KR)

(21) Appl. No.: 13/047,143

(22) Filed: Mar. 14, 2011

(30) Foreign Application Priority Data
Jan. 10, 2011 (KR) 1020110002419

(51) Int. Cl. H01B 1/12

(52) U.S. Cl. 252/500

(57) ABSTRACT

Disclosed is a conductive polymer composition including a conductive polymer, a dopant, a solvent, and a thixotropic agent. The conductive polymer composition includes the thixotropic agent in lieu of a binder, so that the viscosity of the conductive polymer composition is high and the electrical conductivity thereof is superior. The thixotropic agent can reversibly change the viscosity by expansion and shrinkage, thus adjusting the viscosity of the conductive polymer composition depending on the end uses.

### CROSS REFERENCE TO RELATED APPLICATION

This application claims the benefit of Korean Patent Application No. 10-2011-0002419, filed Jan. 10, 2011, entitled “Conductive polymer composition and conductive film prepared from the composition,” which is hereby incorporated by reference in its entirety into this application.

### BACKGROUND OF THE INVENTION

1. Technical Field

The present invention relates to a conductive polymer composition and a conductive film manufactured using the same.

2. Description of the Related Art

Alongside the growth of computers using digital technology, devices assisting computers have also been developed, and personal computers, portable transmitters and other personal information processors are used to process text and graphics using a variety of input devices such as keyboards, mouse elements and so forth.

The rapid advancement of the information-based society, which is disseminating the use of computers, is accompanied by the problem of difficulty in efficiently operating products using only the keyboard and the mouse to perform the functions of an input device. Accordingly, there is increasing demand for devices which are simple and infrequently malfunction, and which enable information to be easily input by anyone. [symbol] enable information to be easily input by anyone.

Furthermore, technology for input devices has surpassed the mere level of fulfilling general functions and has progressed toward technology related to high reliability, durability, innovation, designing and manufacturing. To this end, touch panels have been developed as devices capable of inputting information such as text and graphics.

The touch panel is mounted on the display surface of an image display device such as a flat panel display including an electronic organizer, a liquid crystal display (LCD), a plasma display panel (PDP), an electroluminescence (El) element etc., or a cathode ray tube (CRT), so that a user selects the information desired while looking at the image display device. Also, touch panels are generally classifiable as being of a resistive type, a capacitive type, an electromagnetic type, a SAW (Surface Acoustic Wave) type, and an infrared type. The type of touch panel selected is one that is adapted for an electronic product in consideration of signal amplification problems, resolution differences, the degree of difficulty of designing and manufacturing technology, optical properties, electrical properties, mechanical properties, resistance to the environment, input properties, durability and economic benefits of the touch panel. In particular, resistive touch panels and capacitive touch panels are widely and prevalently used in different fields.

In the case of resistive touch panels, they are configured so that upper/lower transparent electrode films are separated from each other by a spacer and are brought into contact with each other by pressing. Particularly useful are digital resistive type and analog resistive type in such a manner that when an upper conductive film having the upper transparent electrode film is pressed by an input element such as a finger, a pen, etc., the upper/lower transparent electrode films are electrically connected with each other, and changes in voltage in response to changes in resistance at the touch position are sensed by the controller to thus recognize the touch coordinates.

In the case of capacitive touch panels, an upper conductive film having a first transparent electrode and a lower conductive film having a second transparent electrode are spaced apart from each other, and an insulating material is interposed between the first transparent electrode and the second transparent electrode so that these transparent electrodes do not come into contact with each other. Furthermore, electrode wires which are connected to the transparent electrodes are formed on the upper conductive film and the lower conductive film. The electrode wires transfer changes in capacitance occurring from the first transparent electrode and the second transparent electrode to the controller as the touch screen is touched by the input element.

The transparent electrodes have been conventionally formed using ITO (Indium Tin Oxide), but thorough research into conductive polymers as alternatives thereof is ongoing. The conductive polymers are advantageous because of higher flexibility and a simpler coating process, compared to ITO. Because of such advantages, the conductive polymers are receiving attention as an important element of flexible displays corresponding to next-generation technology, as well as the touch panels.

Also, a conductive polymer composition includes a binder for enhancing the force of adhesion to a substrate. The binder may increase the specific surface area of the conductive polymer or may immobilize the conductive polymer chains by the chemical bonding with conductive polymer chains, thus increasing the viscosity of the conductive polymer composition.

However, conventional binders that increase the viscosity of the conductive polymer composition are problematic because they decrease electrical conductivity. Also, the chemical bonding between the binder and the conductive polymer is irreversible, and thus the viscosity of the conductive polymer composition cannot be lowered again, undesirably limiting the end uses thereof.

### SUMMARY OF THE INVENTION

Accordingly, the present invention has been made bearing in mind the problems encountered in the related art and the present invention is intended to provide a conductive polymer composition, which includes a thixotropic agent in lieu of the binder, and thus exhibits high viscosity and superior electrical conductivity.

An aspect of the present invention provides a conductive polymer composition comprising a conductive polymer, a dopant, a solvent and a thixotropic agent.

In this aspect, the thixotropic agent may be any one selected from among polyvinyl-, polyether-, polyacryl-, and cellulose-based derivatives.

In this aspect, the conductive polymer composition may comprise 100 parts by weight of the conductive polymer, 10˜90 parts by weight of the dopant, 5000˜50000 parts by weight of the solvent, and 1˜20 parts by weight of the thixotropic agent. In this aspect, the thixotropic agent may be used in an amount of 2˜10 parts by weight relative to 100 parts by weight of the conductive polymer.

In this aspect, the conductive polymer may be any one selected from among polythiophene-, polypyrrole-, polyphenylene-, polyaniline-, and polyacetylene-based conductive polymers.

In this aspect, the polythiophene-based conductive polymer may be polyethylenedioxythiophene/polystyrenesulfonate (PEDOT/PSS).

In this aspect, the dopant may be one or more selected from among polar solvents including dimethylsulfoxide (DMSO), N-methylpyrrolidone (NMP), N,N-dimethylformamide (DMF) and N-dimethylacetimide (DMA).

In this aspect, the solvent may be one or more selected from among aliphatic alcohol, aliphatic ketone, aliphatic carboxylic acid ester, aliphatic carboxylic acid amide, aliphatic ketone, aliphatic carboxylic acid ester, aliphatic carboxylic acid amide, aromatic hydrocarbon, aliphatic hydrocarbon, acetonitrile, and aliphatic sulfoxide.

Another aspect of the present invention provides a conductive film comprising a base member and a transparent electrode formed by coating the base member with a conductive polymer composition comprising a conductive polymer, a dopant, a solvent and a thixotropic agent and drying it.

In this aspect, the thixotropic agent may be any one selected from among polyvinyl-, polyether-, polyacryl-, and cellulose-based derivatives.

In this aspect, the conductive polymer composition may comprise 100 parts by weight of the conductive polymer, 10˜90 parts by weight of the dopant, 5,000˜50,000 parts by weight of the solvent, and 1˜20 parts by weight of the thixotropic agent.

In this aspect, the thixotropic agent may be used in an amount of 2˜10 parts by weight relative to 100 parts by weight of the conductive polymer.

In this aspect, the conductive polymer may be any one selected from among polythiophene-, polypyrrole-, polyphenylene-, polyaniline-, and polyacetylene-based conductive polymers.

In this aspect, the polythiophene-based conductive polymer may be polyethylenedioxythiophene/polystyrenesulfonate (PEDOT/PSS).

In this aspect, the dopant may be one or more selected from among polar solvents including dimethylsulfoxide (DMSO), N-methylpyrrolidone (NMP), N,N-dimethylformamide (DMF), and N-dimethylacetimide (DMA).

In this aspect, the solvent may be one or more selected from among aliphatic alcohol, aliphatic ketone, aliphatic carboxylic acid ester, aliphatic carboxylic acid amide, aromatic hydrocarbon, aliphatic hydrocarbon, acetonitrile, and aliphatic sulfoxide.

### BRIEF DESCRIPTION OF THE DRAWINGS

The above and other objects, features and advantages of the present invention will be more clearly understood from the following detailed description taken in conjunction with the accompanying drawing, in which:

FIG. 1 is a sectional view showing a conductive film according to an embodiment of the present invention.

### DESCRIPTION OF SPECIFIC EMBODIMENTS

The features and advantages of the present invention will be more clearly understood from the following detailed description and embodiments taken in conjunction with the accompanying drawings. Furthermore, descriptions of known techniques, even if they are pertinent to the present invention, are considered unnecessary and may be omitted in so far as they would make the characteristics of the invention unclear.

Furthermore, the terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept implied by the term to best describe the method he or she knows for carrying out the invention.

Hereinafter, embodiments of the present invention will be described in detail with reference to the attached drawing.

According to the present invention, a conductive polymer composition comprises a conductive polymer, a dopant, a solvent, and a thixotropic agent. In the present invention, a thixotropic agent is used in lieu of a binder which is conventionally employed, and thereby electrical conductivity of the conductive polymer composition is not decreased and the viscosity thereof may be increased. Below, the components of the conductive polymer composition are specified.

The conductive polymer is an electrically conductive polymer having a single π-electron per carbon atom, with a molecular weight of about 10,000 or more. The conductive polymer is advantageous because a thin film which is lighter and more flexible may be obtained than when typically using ITO (Indium Tin Oxide) as a transparent electrode. Such a π-conjugated conductive polymer may be any one selected from among polythiophene-, polypyrrole-, polyphenylene-, polyaniline-, and polyacetylene-based conductive polymers.

Particularly useful is a polythiophene-based conductive polymer, which is exemplified by polyethylenedioxythiophene/polystyrenesulfonate (PEDOT/PSS), for example, Clevios P available from H. C. Starck. This polyethylenedioxythiophene (PEDOT) is doped with a dopant namely polystyrenesulfonate (PSS) and is thus well-dissolved in water with very good thermal stability. Furthermore, in order to maintain the optimal dispersibility of PEDOT in water, PEDOT and PSS have a solid content of 1.0˜1.5 wt %. Further, because PEDOT may be mixed with water, alcohol or a solvent having high dielectric constant, it may be diluted with the solvent and may thus be easily applied. Even when forming a coating film therefrom, this exhibits superior transparency to that of other conductive polymers, such as polyanilines, polypyrroles, and so forth.

Also, the thixotropic agent is used to increase the viscosity of the conductive polymer composition. When the viscosity of the conductive polymer composition is increased in this way, the force of adhesion to a base member may be enhanced, and transparent electrode patterning may be easily performed on the base member.

The thixotropic agent is advantageous because the viscosity of the conductive polymer composition may be increased while the electrical conductivity thereof is not decreased. Furthermore, in the case where the thixotropic agent, which is added to the conductive polymer composition so that the viscosity of the conductive polymer composition is increased, is subjected to shear force such as stirring, it manifests reversible properties in which the viscosity is decreased again. Hence, the viscosity of the conductive polymer composition may be adjusted so as to be adapted for the end uses thereof. The principle in which the viscosity of the conductive polymer composition is increased by the thixotropic agent is as follows.

In the case where a thixotropic agent is dissolved in a solvent, it is dissociated into high molecular ions and low molecular ions, thus generating negative charges. In the case where negative charges are generated on high molecular ions of the thixotropic agent, these high molecules may expand due to electrical repulsion between them by the van der Waals force. When such high molecules expand in this way, the specific surface area is increased, thus increasing the viscosity of the conductive polymer composition.

When the effective charges of high molecular ions of the thixotropic agent are continuously increased, low molecules of the thixotropic agent are distributed around the high molecules by the electrical attraction. In the case where the high molecules of the thixotropic agent are enclosed with the low molecules, the effective charges of the high molecules are reduced, so that electrical repulsion becomes weakened. Hence, while the high molecules are entangled like skeins of thread, the specific surface area is reduced and thus the viscosity is decreased again. Because such a reaction that the viscosity decreases has a low reaction rate, it does not occur at normal times. When the thixotropic agent is subjected to shear force such as stirring, the number of effective collisions between high molecules and low molecules of the thixotropic agent is increased, thus promoting the reduction in effective charges of the high molecules, thereby lowering the viscosity of the molecules, thereby lowering the viscosity of the thixotropic agent. Accordingly, adding the thixotropic agent may increase the viscosity of the conductive polymer composition, and applying the shear force may decrease the viscosity again, whereby the viscosity of the conductive polymer composition may be adjusted so as to be adapted for the end uses.

The thixotropic agent may be any one selected from among polyvinyl-, polyether-, polyacryl-, and cellulose-based derivatives. Particularly useful is a polyacryl-based thixotropic agent. The polyacryl-based thixotropic agent may increase the viscosity of the conductive polymer composition even when used in small amounts. Examples of the polyacryl-based thixotropic agent include, but are not limited to, sodium polyacrylate, polyacrylic acid ester copolymers, etc.

The thixotropic agent is used in an amount of 1˜20 parts by weight relative to 100 parts by weight of the conductive polymer. Particularly favored is 2˜10 parts by weight. If the thixotropic agent is used in an amount less than 1 part by weight relative to 100 parts by weight of the conductive polymer, there is almost no effect of increasing the viscosity of the conductive polymer composition due to the addition of a thixotropic agent. In contrast, if the thixotropic agent is used in an amount larger than 20 parts by weight, the electrical conductivity of the conductive polymer composition is decreased.

The dopant which is a charge carrier of the conductive polymer is added to dope the conductive polymer, and thus functions to increase the electrical conductivity of the conductive polymer composition. An example of the dopant includes an organic compound containing oxygen and nitrogen, for instance, an ether group-containing compound, a carbonyl group-containing compound, a polar solvent, or a mixture thereof.

An example of the ether group-containing compound as the dopant includes diethyleneglycolmonoethylether, and an example of the carbonyl group-containing compound includes isophorone, propylene carbonate, cyclohexanone or butyrolactone. The polar solvent favorably plays a role in increasing the electrical conductivity of the favorably plays a role in increasing the electrical conductivity of the conductive polymer composition and is thus mainly used. The polar solvent may include one or more selected from among dimethylsulfoxide (DMSO), N-methylpyrrolidone (NMP), N,N-dimethylformamide (DMF), and N-dimethylacetimide (DMA).

The dopant is used in an amount of 10˜90 parts by weight, particularly favored being 20˜70 parts by weight, relative to 100 parts by weight of the conductive polymer. If the dopant is used in an amount less than 10 parts by weight, the degree of improving electrical conductivity becomes insignificant. In contrast, if the dopant is used in an amount larger than 90 parts by weight, the electrical conductivity is not decreased even when the dopant is added, and undesirably the dopant may waste.

The solvent is added to disperse the conductive polymer in a solution. The solvent may include, but is not limited to, any one selected from among aliphatic alcohol, aliphatic ketone, aliphatic carboxylic acid ester, aliphatic carboxylic acid amide, aromatic hydrocarbon, aliphatic hydrocarbon, acetonitrile, aliphatic sulfoxide, water, and mixtures thereof. The solvent is used in an amount of 5,000˜50,000 parts by weight, particularly favored being 7,000˜30,000 parts by weight, relative to 100 parts by weight of the conductive polymer. If the solvent is used in an amount less than 5,000 parts by weight, the dispersibility of the conductive polymer is decreased. In contrast, if the solvent is used in an amount larger than 50,000 parts by weight, the electrical conductivity of the conductive polymer composition is decreased.

Also, the conductive polymer composition may further comprise other additives, such as a dispersion stabilizer, a surfactant, an antifoamer, etc.

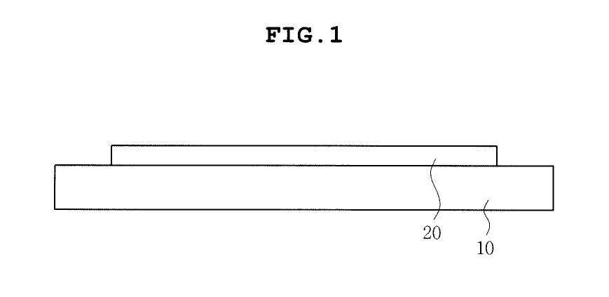

In addition, a conductive film according to the present invention, as shown in FIG. 1, includes a base member 10, and a transparent electrode 20 formed by coating the base member 10 with a conductive polymer composition comprising a conductive polymer, a dopant, a solvent and a thixotropic agent and then drying it. The conductive film according solvent and a thixotropic agent and then drying it. The conductive film according to the present invention is manufactured by patterning the transparent electrode 20 using the conductive polymer composition including the thixotropic agent, so that the transparent electrode 20 is uniformly and accurately formed and has high electrical conductivity. Below, the elements of the conductive film are individually described, and the description that overlaps with the aforementioned description is omitted or simply mentioned.

The base member 10 which is transparent includes a glass substrate, a film substrate, a fiber substrate, or a paper substrate. In particular, the film substrate may be made of polyethyleneterephthalate (PET), polymethylmethacrylate (PMMA), polypropylene (PP), polyethylene (PE), polyethylenenaphthalene dicarboxylate (PEN), polycarbonate (PC), polyethersulfone (PES), polyimide (PI), polyvinyl alcohol (PVA), cyclic olefin copolymer (COC), or styrene copolymer, but the present invention is not necessarily limited thereto.

As shown in FIG. 1, the transparent electrode 20, which is formed on one side of the base member 10, plays a role in sensing changes in capacitance (capacitive type) or changes in resistance (resistive type) when a touch screen is touched by the finger of a user. Such a transparent electrode 20 may be provided in the form of a plurality of transparent electrode 20 patterns of capacitive type or digital resistive type, or of a single film of analog resistive type.

The transparent electrode 20 is formed by applying the conductive polymer composition comprising the conductive polymer, the dopant, the solvent and the thixotropic agent and then drying it. The conductive film according to the present invention includes the transparent electrode 20 which is uniformly and accurately formed and has high electrical conductivity by patterning the transparent electrode 20 with a highly viscous conductive polymer composition including the thixotropic agent. Furthermore, because the force of adhesion between the conductive polymer composition and the base member 10 is conductive polymer composition and the base member 10 is high due to the use of the thixotropic agent, the durability and stability of the conductive film are improved.

The transparent electrode 20 may be formed by patterning the conductive polymer composition on the base member 10 using a dry process or a wet process and then drying it. The dry process includes sputtering, evaporation, etc., and the wet process includes dip coating, spin coating, roll coating, spray coating, etc.

The base member 10 coated with the conductive polymer composition is then dried. When the applied conductive polymer composition is dried, the transparent electrode 20 is provided in fixed form. The drying process includes hot air drying, IR drying, etc.

### Example 1

Into a 100 ml round-bottom reactor, 400 g of a solvent n-butanol, 7.1 g of a dopant DMSO, 6.84 g of a conductive polymer PEDOT/PSS, and 0.07 g (corresponding to 1 part by weight relative to 100 parts by weight of a conductive polymer) of a polyacryl-based thixotropic agent were added, after which 30-min stirring and sonification were performed, thus preparing a PEDOT/PSS conductive polymer composition. The conductive polymer composition was applied on a base member using spin coating and then dried in an oven at 70° C. for 30 min, thus manufacturing a conductive film.

### Example 2

A conductive polymer composition was prepared in the same manner as in Example 1, with the exception that 0.137 g of a polyacryl-based thixotropic agent was added so as to reach 2 parts by weight of a thixotropic agent relative to 100 parts by weight of a conductive polymer.

The conductive polymer composition was applied on a base member using spin coating and then dried in an oven at 70° C. for 30 min, thus manufacturing a conductive and then dried in an oven at 70° C. for 30 min, thus manufacturing a conductive film.

### Example 3

A conductive polymer composition was prepared in the same manner as in Example 1, with the exception that 0.342 g of a polyacryl-based thixotropic agent was added so as to reach 5 parts by weight of a thixotropic agent relative to 100 parts by weight of a conductive polymer.

The conductive polymer composition was applied on a base member using spin coating and then dried in an oven at 70° C. for 30 min, thus manufacturing a conductive film.

### Example 4

A conductive polymer composition was prepared in the same manner as in Example 1, with the exception that 0.684 g of a polyacryl-based thixotropic agent was added so as to reach 10 parts by weight of a thixotropic agent relative to 100 parts by weight of a conductive polymer.

The conductive polymer composition was applied on a base member using spin coating and then dried in an oven at 70° C. for 30 min, thus manufacturing a conductive film.

### Example 5

A conductive polymer composition was prepared in the same manner as in Example 1, with the exception that 3.42 g of a polyacryl-based thixotropic agent was added so as to reach 50 parts by weight of a thixotropic agent relative to 100 parts by weight of a conductive polymer.

The conductive polymer composition was applied on a base member using spin coating and then dried in an oven at 70° C. for 30 min, thus manufacturing a conductive film.

### Comparative Example

A conductive polymer composition was prepared in the same manner as in Example 1, with the exception that 0.684 g of an acrylic binder was added instead of the polyacryl-based thixotropic agent.

The conductive polymer composition was applied on a base member using spin coating and then dried in an oven at 70° C. for 30 min, thus manufacturing a conductive film.

### Test Example

The viscosity of the conductive polymer compositions of Examples 1 to 5 and Comparative Example and the electrical conductivity of the conductive film manufactured therefrom were measured. Specifically, the viscosity of the conductive polymer composition was measured under conditions of 22° C., Spindle: #63, and Speed: 60 rpm using a Brookfield viscometer. The electrical conductivity of the conductive film was measured using Loresta EP MCP-T360 available from Mitsubishi Chemical.

TABLE 1

| | Viscosity of Conductive | Sheet Resistance of |
|---|---|---|
| | Polymer Composition (mPa · s) | Conductive Film (Ω/□) |
| Ex. 1 | 100 | 160 |
| Ex. 2 | 170 | 180 |
| Ex. 3 | 310 | 205 |
| Ex. 4 | 600 | 450 |
| Ex. 5 | 4000 | 1100 |
| C. Ex. | 670 | 860 |

As is apparent from Table 1, when the thixotropic agent was used, the sheet resistance of the conductive film was lower thus obtaining superior electrical conductivity, compared to when using the binder (Comparative Example), and the viscosity of the using the binder (Comparative Example), and the viscosity of the conductive polymer composition was increased to the level similar thereto. As such, when the thixotropic agent was added in an amount of 2˜10 parts by weight relative to 100 parts by weight of the conductive polymer, the viscosity of the conductive polymer composition was high and the electrical conductivity of the conductive film was superior.

As described hereinbefore, the present invention provides a conductive polymer composition and a conductive film manufactured using the same. According to the present invention, the conductive polymer composition includes a thixotropic agent in lieu of a binder, thus ensuring high viscosity and superior electrical conductivity of the conductive polymer composition.

Also according to the present invention, the viscosity can be reversibly changed thanks to the expansion and shrinkage of the thixotropic agent, and thus the viscosity of the conductive polymer composition can be adjusted so as to be adapted for the end uses.

Although the embodiments of the present invention regarding the conductive polymer composition and the conductive film manufactured using the same have been disclosed for illustrative purposes, those skilled in the art will appreciate that a variety of different modifications, additions and substitutions are possible, without departing from the scope and spirit of the invention as disclosed in the accompanying claims. Accordingly, such modifications, additions and substitutions should also be understood as falling within the scope of the present invention.

What is claimed is:

1. A conductive polymer composition, comprising a conductive polymer, a dopant, a solvent and a thixotropic agent.

2. The conductive polymer composition of claim 1, wherein the thixotropic agent is any one selected from among polyvinyl-, polyether-, polyacryl-, and cellulose-based derivatives.

3. The conductive polymer composition of claim 1, comprising 100 parts by weight of the conductive polymer, 10˜90 parts by weight of the dopant, 5,000˜50,000 parts by weight of the solvent, and 1˜20 parts by weight of the thixotropic agent.

4. The conductive polymer composition of claim 1, wherein the thixotropic agent is used in an amount of 2˜10 parts by weight relative to 100 parts by weight of the conductive polymer.

5. The conductive polymer composition of claim 1, wherein the conductive polymer is any one selected from among polythiophene-, polypyrrole-, polyphenylene-, polyaniline-, and polyacetylene-based conductive polymers.

6. The conductive polymer composition of claim 5, wherein the polythiophene-based conductive polymer is polyethylenedioxythiophene/polystyrenesulfonate (PEDOT/PSS).

7. The conductive polymer composition of claim 1, wherein the dopant is one or more selected from among polar solvents including dimethylsulfoxide (DMSO), N-methylpyrrolidone (NMP), N,N-dimethylformamide (DMF), and N-dimethylacetimide (DMA).

8. The conductive polymer composition of claim 1, wherein the solvent is one or more selected from among aliphatic alcohol, aliphatic ketone, aliphatic carboxylic acid ester, aliphatic carboxylic acid amide, aromatic hydrocarbon, aliphatic hydrocarbon, acetonitrile, and aliphatic sulfoxide.

9. A conductive film, comprising:
a base member; and
a transparent electrode formed by coating the base member with a conductive polymer composition comprising a conductive polymer, a dopant, a solvent and a thixotropic agent and drying it.

10. The conductive film of claim 9, wherein the thixotropic agent is any one selected from among polyvinyl-, polyether-, polyacryl-, and cellulose-based derivatives.

11. The conductive film of claim 9, wherein the conductive polymer composition comprises 100 parts by weight of the conductive polymer, 10˜90 parts by weight of the dopant, 5,000˜50,000 parts by weight of the solvent, and 1˜20 parts by weight of the thixotropic agent.

12. The conductive film of claim 9, wherein the thixotropic agent is used in an amount of 2˜10 parts by weight relative to 100 parts by weight of the conductive polymer.

13. The conductive film of claim 9, wherein the conductive polymer is any one selected from among polythiophene-, polypyrrole-, polyphenylene-, polyaniline-, and polyacetylene-based conductive polymers.

14. The conductive film of claim 9, wherein the polythiophene-based conductive polymer is polyethylenedioxythiophene/polystyrenesulfonate (PEDOT/PSS).

15. The conductive film of claim 9, wherein the dopant is one or more selected from among polar solvents including dimethylsulfoxide (DMSO), N-methylpyrrolidone (NMP), N,N-dimethylformamide (DMF), and N-dimethylacetimide (DMA).

16. The conductive film of claim 9, wherein the solvent is one or more selected from among aliphatic alcohol, aliphatic ketone, aliphatic carboxylic acid ester, aliphatic carboxylic acid amide, aromatic hydrocarbon, aliphatic hydrocarbon, acetonitrile, and aliphatic sulfoxide.
